(19) United States
(12) Patent Application Publication
(10) Pub. No.: US 2025/0379652 A1
(43) Pub. Date: Dec. 11, 2025

(54) STATE-OF-POLARIZATION MONITORING APPARATUS, STATE-OF-POLARIZATION MONITORING METHOD, AND NON-TRANSITORY COMPUTER-READABLE STORAGE MEDIUM

(71) Applicant: NEC Corporation, Tokyo (JP)

(72) Inventor: Mingqi WU, Tokyo (JP)

(73) Assignee: NEC Corporation, Tokyo (JP)

(21) Appl. No.: 19/230,633

(22) Filed: Jun. 6, 2025

(30) Foreign Application Priority Data
Jun. 11, 2024 (JP) 2024-094389

(51) Int. Cl. H04B 10/079; G01J 4/00

(52) U.S. Cl. CPC H04B 10/0795; G01J 4/00

(57) ABSTRACT

A state-of-polarization monitoring method according to the present disclosure computes a state-of-polarization change vector representing a change in the state of polarization of an optical reception signal for each of different periods, and determines a characteristic of the change in the state of polarization of the optical reception signal based on a direction of each of the state-of-polarization change vectors, a length of each of the state-of-polarization change vectors, or both of them.

### INCORPORATION BY REFERENCE

This application is based upon and claims the benefit of priority from Japanese patent application No. 2024-094389, filed on Jun. 11, 2024, the disclosure of which is incorporated herein in its entirety by reference.

### TECHNICAL FIELD

The present disclosure relates to a state-of-polarization monitoring apparatus, a state-of-polarization monitoring method, and a non-transitory computer-readable storage medium.

### BACKGROUND ART

Techniques for monitoring a change in the state of polarization (SOP) of an optical signal in an optical communication system have been developed. For example, NPL 1 discloses a technique for monitoring a change in the state of polarization of an optical reception signal that has been modulated by Quadrature Phase-Shift Keying (QPSK). A system disclosed in NPL 1 computes a plurality of Jones vectors from an optical reception signal, and maps each of the computed Jones vectors to a point in a Stokes space. Next, the system disclosed in NPL 1 divides the plurality of points obtained by the mapping into four groups, and computes the center point of each of the groups. Further, the system disclosed in NPL 1 computes a normal vector based on the computed four center points. The system disclosed in NPL 1 monitors the state of polarization of the optical reception signal based on the rotation speed of the normal vector computed as described above.

### CITATION LIST

### Non Patent Literature

NPL 1: Jingnan Li, Yangyang Fan, Zhenning Tao, Hisao Nakashima, and Takeshi Hoshida, “Polarization Change Monitor Based on Geometrical Analysis in Stokes Space”, 2021 European Conference on Optical Communication (ECOC), Nov. 22, 2021.
NPL 2: Bogdan Szafraniec, Todd S. Marshall, and Bernd Nebendahl, “Performance Monitoring and Measurement Techniques for Coherent Optical Systems”, Journal of Lightwave Technology, Feb. 15, 2013, vol. 31, no. 4, pp. 648-663

### SUMMARY

The inventors of the present disclosure have found a new technique for monitoring the state of polarization of an optical reception signal. An objective of the present disclosure is to provide a new technique for monitoring the state of polarization of an optical reception signal.

A state-of-polarization monitoring apparatus according to the present disclosure includes at least one memory that is configured to store instructions and at least one processor that is configured to execute the instructions to: computing a state-of-polarization change vector representing a change in the state of polarization of an optical reception signal for each of different periods; and determining a characteristic of the change in the state of polarization of the optical reception signal based on a direction of each of the state-of-polarization change vectors, a length of each of the state-of-polarization change vectors, or both of them.

A state-of-polarization monitoring method according to the present disclosure is performed by a computer. The method includes: computing a state-of-polarization change vector representing a change in the state of polarization of an optical reception signal for each of different periods; and determining a characteristic of the change in the state of polarization of the optical reception signal based on a direction of each of the state-of-polarization change vectors, a length of each of the state-of-polarization change vectors, or both of them.

A non-transitory computer-readable medium according to the present disclosure stores a program that causes a computer to perform: computing a state-of-polarization change vector representing a change in the state of polarization of an optical reception signal for each of different periods; and determining a characteristic of the change in the state of polarization of the optical reception signal based on a direction of each of the state-of-polarization change vectors, a length of each of the state-of-polarization change vectors, or both of them.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 shows an example of an optical transceiver system handled by a state-of-polarization monitoring apparatus;

FIG. 2 shows an example of an overview of operations performed by the state-of-polarization monitoring apparatus;

FIG. 3 is a block diagram showing an example of a functional configuration of the state-of-polarization monitoring apparatus;

FIG. 4 is a block diagram showing an example of a hardware configuration of a computer by which the state-of-polarization monitoring apparatus is implemented;

FIG. 5 is a flowchart showing an example of a flow of processes executed by the state-of-polarization monitoring apparatus;

FIG. 6 shows an example case (Case 1) in which the end point of a state-of-polarization vector rotates large and fast;

FIG. 7 shows an example case (Case 2) in which the end point of a state-of-polarization vector rotates large and slowly;

FIG. 8 shows an example case (Case 3) in which the end point of a state-of-polarization vector rotates small;

FIG. 9 shows an example case (Case 4) in which the end point of a state-of-polarization vector does not rotate; and

FIG. 10 is a flowchart showing an example of a flow of processes for determining a characteristic of changes in the state of polarization from among the four cases.

### EXAMPLE EMBODIMENT

An example embodiment according to the present disclosure will be described in detail hereinafter with reference to the drawings. The same or corresponding elements are assigned the same reference numerals (or symbols) throughout the drawings, and redundant descriptions thereof will be omitted as appropriate for clarifying the explanation. Further, unless otherwise described, pre-defined value such as predetermined values and thresholds are stored in advance in a storage device or the like accessible from an apparatus that uses these values. Further, unless otherwise described, the storage unit is formed by one or an arbitrary number of storage devices.

### First Example Embodiment

### <Overview>

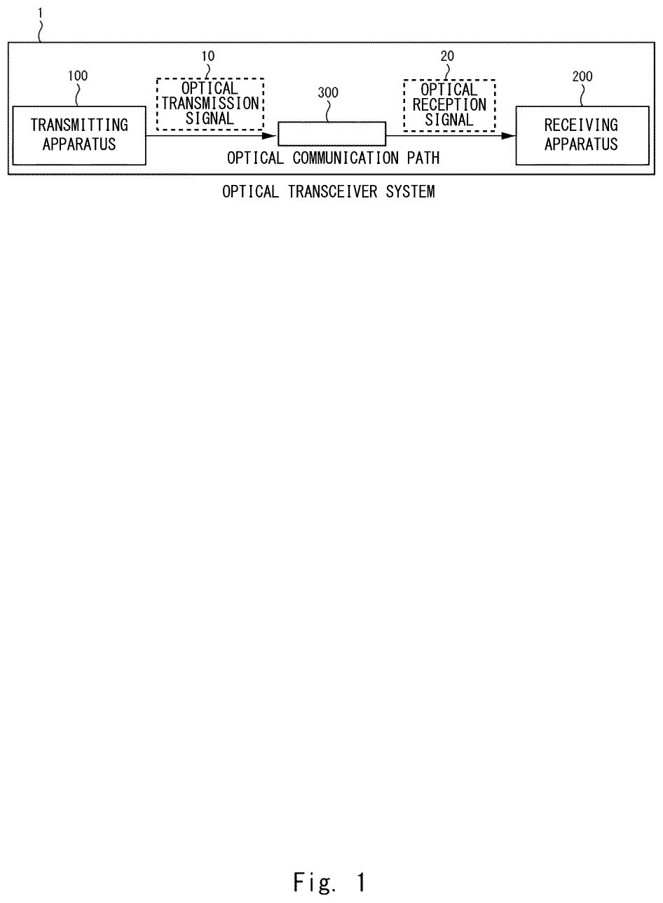

FIG. 1 shows an example of an optical transceiver system to which a state-of-polarization monitoring apparatus according to an aspect of the present disclosure is applied. The optical transceiver system 1 includes a transmitting apparatus 100, a receiving apparatus 200, and an optical communication path 300. The receiving apparatus 200 receives an optical signal transmitted from the transmitting apparatus 100 through the optical communication path 300. The optical communication path 300 is a communication path through which an optical signal can be transmitted, and is formed, for example, by using an optical fiber. Note that an optical signal transmitted from the transmitting apparatus 100 and an optical signal received by the receiving apparatus 200 are referred to as an optical transmission signal 10 and an optical reception signal 20, respectively.

Communication between the transmitting apparatus 100 and the receiving apparatus 200 is performed, for example, as follows. The transmitting apparatus 100 generates an optical transmission signal 10 from data (hereinafter also referred to as a message) to be transmitted to the receiving apparatus 200. Specifically, the transmitting apparatus 100 divides the message into a plurality of frames, and generates a symbol sequence by encoding data of each frame into a symbol. Then, the transmitting apparatus 100 modulates each of an X-polarized wave and a Y-polarized wave of an optical carrier wave based on the symbol sequence, and thereby generates the optical transmission signal 10 that is dual-polarized.

The receiving apparatus 200 restores a message from an optical reception signal 20. To do so, the receiving apparatus 200 converts the optical reception signal 20 into a digital signal. Further, the receiving apparatus 200 obtains a symbol sequence by dividing the obtained digital signal into a plurality of frames and converting each of the frames into a symbol. Then, the receiving apparatus 200 obtains a message by decoding each of the symbols of the symbol sequence.

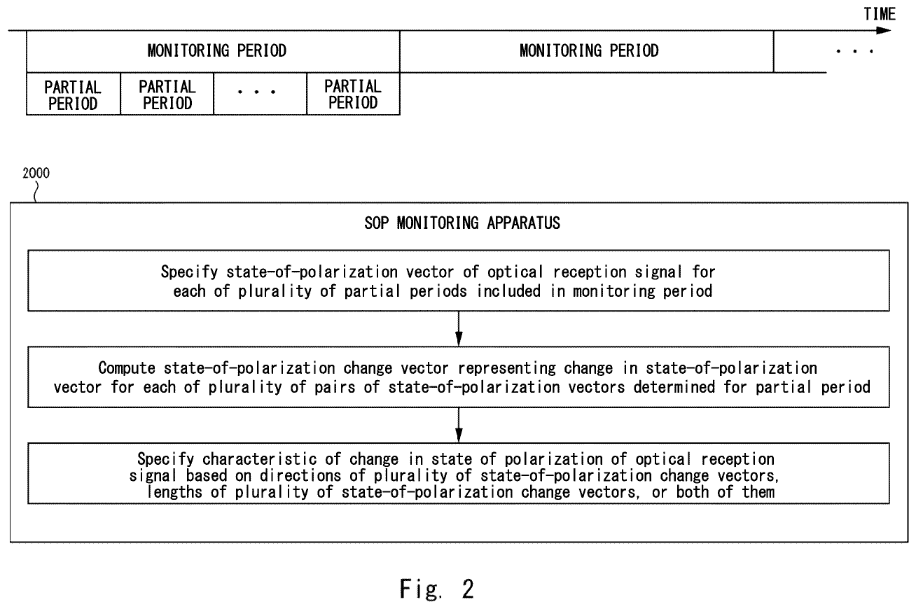

FIG. 2 shows an example of an overview of operations performed by a state-of-polarization monitoring apparatus 2000. Note that FIG. 2 is a diagram for facilitating the understanding of the overview of the state-of-polarization monitoring apparatus 2000, and the operations performed by the state-of-polarization monitoring apparatus 2000 are not limited to those shown in FIG. 2. The state-of-polarization monitoring apparatus 2000 monitors changes in the state of polarization (SOP) of the optical reception signal 20. More specifically, the SOP monitoring apparatus 2000 determines a characteristic of changes in the state of polarization of the optical reception signal 20 for each of one or more periods (hereinafter also referred to as a monitoring period(s)). For example, the characteristic of changes in the state of polarization is classified into one of plurality of predetermined cases.

The monitoring period can be arbitrarily determined. For example, a plurality of monitoring periods can be obtained by dividing a period during which the SOP monitoring apparatus 2000 is receiving an optical reception signal 20 into a plurality of periods each having a predetermined length.

Hereinafter, the monitoring period in which the characteristic of changes in the state of polarization is determined is referred to as target monitoring period. For example, it is assumed that the SOP monitoring apparatus 2000 attempts to determine the characteristic of changes in the state of polarization for an i-th monitoring period. In this case, this i-th monitoring period is referred to as the target monitoring period.

By handling each of a plurality of monitoring periods as the target monitoring period, the SOP monitoring apparatus 2000 determines the characteristic of changes in the state of polarization for each of the monitoring periods. For example, the plurality of monitoring periods are handled as the target monitoring period one after another in chronological order.

The state of polarization of the optical reception signal 20 can be represented by a vector in a Stokes space. Hereinafter, a vector in the Stokes space representing the state of polarization of an optical reception signal 20 is referred to as a “state-of-polarization vector (SOP vector)”. The SOP vector is a vector whose initial point is the origin of the Stokes space and the ending point is a point in the Stokes space representing the state of polarization of the optical reception signal 20. Hereinafter, a point in the Stokes space representing the state of polarization of an optical reception signal 20 is referred to as a “SOP point”

The SOP monitoring apparatus 2000 computes a plurality of state-of-polarization change vectors (SOP change vectors) representing changes in the state of polarization for the target monitoring period. The SOP change vectors are expressed, for example, by a difference between two SOP vectors.

More specifically, the SOP monitoring apparatus 2000 computes an SOP vector representing the state of polarization in each of a plurality of partial periods included in the target monitoring period. The partial periods are obtained, for example, by dividing the monitoring period into plurality of sections each having predetermined length. The SOP monitoring apparatus 2000 computes a plurality of SOP change vectors by using a plurality of SOP vectors computed for the target monitoring period. For example, an SOP change vector is computed by computing a difference between two SOP vectors respectively computed for two partial periods adjacent to each other in the chronological order.

The SOP monitoring apparatus 2000 determines the characteristic of changes in the state of polarization of the optical reception signal 20 in the target monitoring period by using a plurality of SOP change vectors computed for the target monitoring period to. This determination is made based on the directions of the SOP change vectors, the lengths of the SOP change vectors, or both of them.

### <Example of Advantageous Effect>

The SOP monitoring apparatus 2000 determines the characteristic of changes in the state of polarization as one of indicators for monitoring the state of polarization of the optical reception signal 20 received by the receiving apparatus 200. This determination is made based on the directions of the SOP change vectors, the lengths of the SOP change vectors, or both of them. As described above, according to the SOP monitoring apparatus 2000, a new technique for monitoring the state of polarization of an optical reception signal is provided.

The SOP monitoring apparatus 2000 according to this example embodiment will be described hereinafter in a more detailed manner.

### <Example of Functional Configuration>

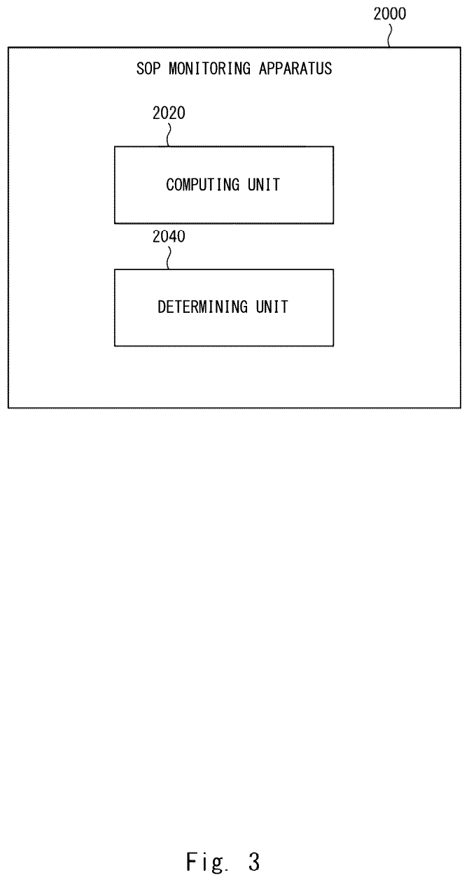

FIG. 3 is a block diagram showing an example of a functional configuration of the SOP monitoring apparatus 2000. The SOP monitoring apparatus 2000 includes a computing unit 2020 and a determining unit 2040. The computing unit 2020 computes a plurality of SOP change vectors for the target monitoring period. The determining unit 2040 determines a characteristic of changes in the state of polarization of the optical reception signal 20 in the target monitoring period based on the directions of the plurality of SOP change vectors, the lengths of the plurality of SOP vectors, or both of them.

Finding out the characteristic of changes in the state of polarization of the optical reception signal 20 has an advantage that it is useful, for example, for selecting an appropriate method for monitoring the state of polarization of the optical reception signal 20. For example, a case in which the end point of the SOP vector of the optical reception signal 20 is rotating small (Case 3 described later) is a case that is unsuitable for a geometric technique (e.g., a technique using Stokes vectors) compared with a case in which the end point of the SOP vector of the optical reception signal 20 is rotating large (Cases 1 and 2 described later). Therefore, for example, by using the SOP monitoring apparatus 2000, it is possible to take measures such as “when the characteristic of changes in the state of polarization of the optical reception signal 20 has the characteristic of Case 3, a monitoring technique other than the geometric technique is selected”.

### <Example of Hardware Configuration>

Each of functional components of the SOP monitoring apparatus 2000 can be implemented by hardware that implements the functional component (e.g., a hardwired electronic circuit or the like) or by a combination of hardware and software (e.g., a combination of an electronic circuit and a program for controlling it or the like). A case where each of the functional components of the SOP monitoring apparatus 2000 is implemented by a combination of hardware and software will be further described hereinafter.

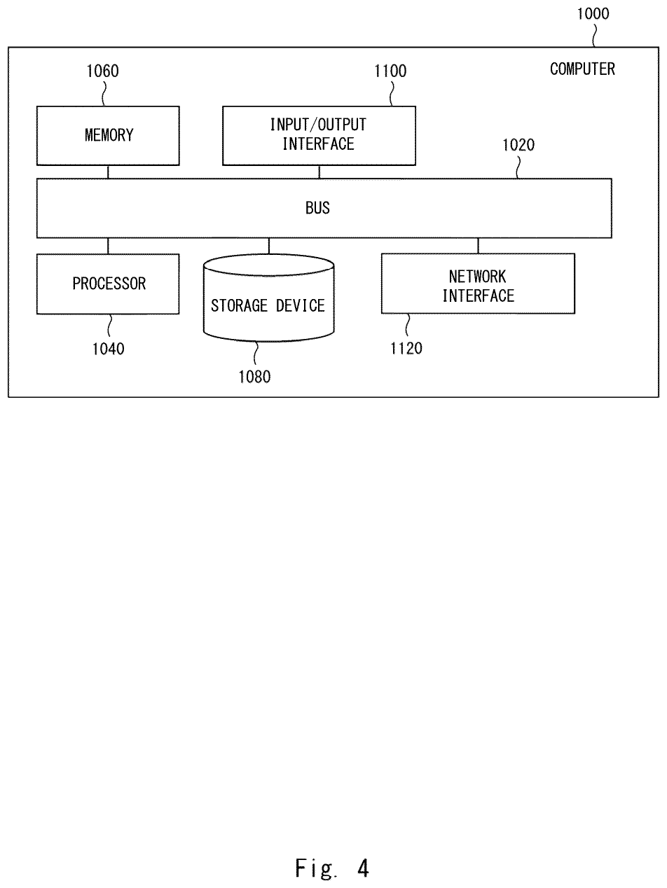

FIG. 4 is a block diagram showing an example of a hardware configuration of a computer 1000 that implements the SOP monitoring apparatus 2000. The computer 1000 is an arbitrary computer. For example, the computer 1000 is a stationary computer such as a server machine or a PC (Personal Computer). Alternatively, for example, the computer 1000 is a portable computer such as a smartphone or a tablet-type terminal. Alternatively, for example, the computer 1000 is a semiconductor chip such as an SoC (System on Chip). The computer 1000 may be a special-purpose computer designed to implement the SOP monitoring apparatus 2000, or may be a general-purpose computer.

For example, each of functions of the SOP monitoring apparatus 2000 is implemented by the computer 1000 by installing a predetermined application in the computer 1000. The aforementioned application is implemented by a program for implementing each of the function components of the SOP monitoring apparatus 2000. Note that how to acquire the aforementioned program is arbitrarily determined. For example, the program can be acquired from a storage medium (such as a Digital Versatile Disk (DVD) or a Universal Serial Bus (USB) memory) in which the program is stored. Alternatively, the program can be acquired, for example, by downloading the program from a server apparatus that manages a storage device in which the program is stored.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and the network interface 1120 transmit and receive data to and from each other. However, the method for connecting the processor 1040 and the like to each other is not limited to connections through buses.

The processor 1040 is any of various types of processors such as a central processing unit (CPU), a graphics processing unit (GPU), digital signal processor (DSP), or a field-programmable gate array (FPGA). The memory 1060 is a primary storage device implemented by using a random access memory (RAM) or the like. The storage device 1080 is a secondary storage device implemented by using a hard disk drive, a solid state drive (SSD), a memory card, or a read only memory (ROM).

The input/output interface 1100 is an interface for connecting the computer 1000 with an input/output device(s). For example, an input device such as a keyboard and an output device such as a display device are connected to the input/output interface 1100.

The network interface 1120 is an interface for connecting the computer 1000 to a network. The network may be a local area network (LAN) or a wide area network (WAN).

In the storage device 1080, programs for implementing respective functional components of the SOP monitoring apparatus 2000 (programs for implementing the above-described applications) are stored. The processor 1040 implements each of functional components of the SOP monitoring apparatus 2000 by loading the aforementioned program onto the memory 1060 and executing the loaded program.

The SOP monitoring apparatus 2000 may be implemented by one computer 1000 or by a plurality of computers 1000. In the latter case, the configurations of the computers 1000 do not need to be identical to each other, but can be different from each other.

The SOP monitoring apparatus 2000 may be implemented as an apparatus separate from the receiving apparatus 200, or may be integrally implemented with the receiving apparatus 200. In the latter case, the various functional components of the SOP monitoring apparatus 2000 are implemented inside the receiving apparatus 200. In this way, the receiving apparatus 200 also functions as the SOP monitoring apparatus 2000.

### <Flow of Processes>

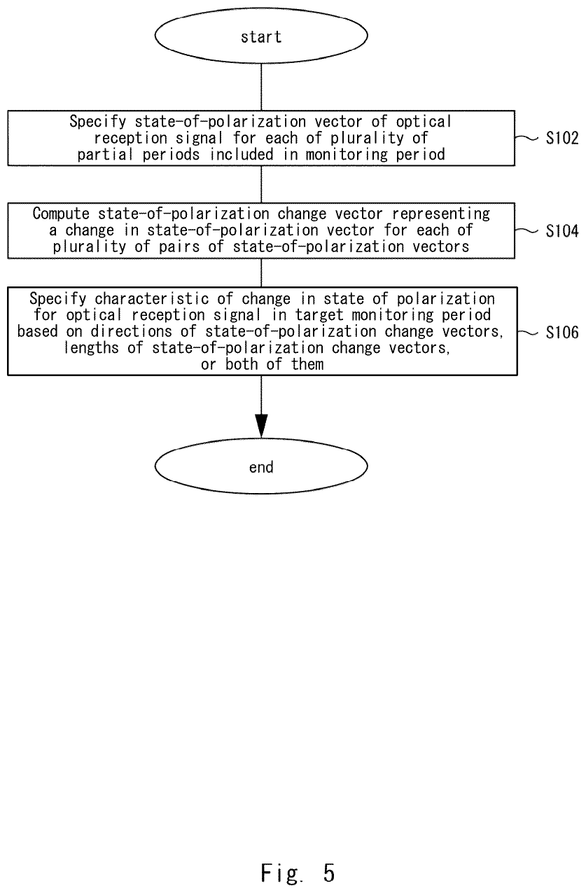

FIG. 5 shows a flowchart showing an example of a flow of processes performed by the SOP monitoring apparatus 2000. The series of processes shown in FIG. 5 is successively (i.e., repeatedly) performed for each of a plurality of target monitoring periods.

The computing unit 2020 determines an SOP vector for each of a plurality of partial periods included in the target monitoring period (S102). The computing unit 2020 computes an SOP change vector for each of a plurality of pairs of SOP vectors (S104).

The determining unit 2040 determines the characteristic of changes in the state of polarization of the optical reception signal 20 in the target monitoring period based on the directions of plurality of SOP change vectors, the lengths of the plurality of SOP change vectors, or both of them (S106).

### <Determination of SOP Vector: S102>

The computing unit 2020 determines an SOP vector for each of a plurality of partial periods (S102). Several methods for determining an SOP vector will be described hereinafter.

### Example 1 of Method for Determining SOP Vector

For example, the computing unit 2020 determines an SOP vector for each partial period by using a polarimeter. When a polarimeter is used to determine an SOP vector, this polarimeter is provided in the receiving apparatus 200 in advance. An optical reception signal 20 is input to the polarimeter.

The polarimeter is an apparatus that measures the state of polarization of the input light. For example, the polarimeter outputs, upon receiving an optical reception signal 20, time-series data {S[t]} of Stokes vectors S each of which represents a state of polarization of the optical reception signal 20 (i.e., time-series data {S[t]} including a plurality of Stokes vectors S arranged in a chronological order). Note that t represents time. The Stokes vector S is a vector in which four types of Stokes parameters s0, s1, s2, and s3 are enumerated.

The Stokes space is a three-dimensional (3D) space defined by three axes, i.e., an s1-axis, an s2-axis, and an s3-axis. Therefore, the SOP vector v[t] of an optical reception signal 20 at a time point t can be expressed as v[t]=(s1[t], s2[t], s3[t]) by using three Stokes parameters s1[t], s2[t], and s3[t] output from the polarimeter to which the optical reception signal 20 is input at the time point t.

Therefore, the computing unit 2020 acquires time-series data of Stokes vectors output from the polarimeter provided in the receiving apparatus 200. Then, the computing unit 2020 determines, for each partial period, the SOP vector for the partial period by using at least one Stokes vector for the partial period.

For example, the computing unit 2020 acquires a representative Stokes vector S[rj] for each partial period j. The time point rj is, for example, a specific time point in the partial period j (e.g., the start point or the end point of the partial period j). Further, the computing unit 2020 extracts Stokes parameters s1[rj], s2[rj], and s3[rj] from the representative Stokes vector S[rj]. Then, the computing unit 2020 determines a vector (s1[rj], s2[rj], s3[rj]) determined by these parameters as the SOP vector for the partial period j.

Alternatively, for example, the computing unit 2020 computes statistical values ss1[j], ss2[j], and ss3[j] of the Stokes parameters s1, s2, and s3, respectively, by using a plurality of Stokes vectors for the partial period j. Then, the computing unit 2020 determines a vector (ss1[j], ss2[j], ss3[j]) determined by the computed statistical values as the SOP vector for the partial period j.

There are various methods by which the computing unit 2020 acquires Stokes vectors output from the polarimeter. For example, the receiving apparatus 200 transmits Stokes vectors output from the polarimeter to the SOP monitoring apparatus 2000. In this case, the computing unit 2020 receives Stokes vectors transmitted from the receiving apparatus 200, and thereby acquires the Stokes vectors. Alternatively, for example, the receiving apparatus 200 stores Stokes vectors output from the polarimeter into a storage unit accessible from the SOP monitoring apparatus 2000. In this case, the computing unit 2020 acquires Stokes vectors from this storage unit.

Note that when only the representative Stokes vector is used to determine the SOP vector, the receiving apparatus 200 may be configured to transmit only the representative Stokes vector or to store only the representative Stokes vector into the storage unit.

### Example 2 of Method for Determining SOP Vector

The computing unit 2020 acquires, each frame of an optical reception signal 20, sample data representing the state of polarization of the optical reception signal 20 in that frame. For example, the sample data is a Jones vector. Further, the computing unit 2020 maps sample data of each frame to a point in a Stokes space, and by doing so, obtains a corresponding point for each sample data.

A Stokes vector S[t]=(s0[t], s1[t], s2[t], s3[t]) can be obtained from sample data at a time point t. Therefore, the computing unit 2020 obtains a point (s1[t], s2[t], s3[t]) as a corresponding point corresponding to the sample data at the time point t.

A Stokes vector S[t] at a time point t can be computed as shown below by using sample data at the time point t.

$$\begin{matrix}[ Equation 1 ] & \\ S [ i ] = ( \begin{matrix}{s}_{0} [ i ] \\ {s}_{1} [ i ] \\ {s}_{2} [ i ] \\ {s}_{3} [ i ]\end{matrix} ) = ( \begin{matrix}{z}_{x} [ i ] {{z}_{x} [ i ]}^{*} + {z}_{y} [ i ] {{z}_{y} [ i ]}^{*} \\ {z}_{x} [ i ] {{z}_{x} [ i ]}^{*} - {z}_{y} [ i ] {{z}_{y} [ i ]}^{*} \\ {{z}_{x} [ i ]}^{*} {z}_{x} [ i ] + {z}_{x} [ i ] {{z}_{y} [ i ]}^{*} \\ - {{jz}_{x} [ i ]}^{*} {z}_{y} [ i ] + {jz}_{x} [ i ] {{z}_{y} [ i ]}^{*}\end{matrix} ) & ( 1 )\end{matrix}$$

z_x[t] represents an x-polarized wave component of the optical reception signal 20 at the time point t, indicated by the sample data at the time point t. z_y[t] represents a y-polarized wave component of the optical reception signal 20 at the time point t, indicated by the sample data at the time point t. * represents conjugate. j represents an imaginary unit. Note that z_x[t] and z_y[t] are both complex numbers.

Note that the number of frames included in the optical reception signal 20 in each partial period is represented by n. In this case, the computing unit 2020 computes one SOP vector for each partial period based on n corresponding points obtained for n frames included in the partial period. Hereinafter, a set of corresponding points obtained for a plurality of frames included in a partial period is referred to as a corresponding point group corresponding to these frames. The corresponding point group of the respective frames includes n corresponding points.

For example, the computing unit 2020 performs the following processes for each partial period. Firstly, the computing unit 2020 computes a plane in a Stokes space that fits to a corresponding point group obtained for the target partial period (i.e., fits to n corresponding points included in the corresponding point group). The computing unit 2020 determines, as the SOP vector, a vector whose ending point is at the intersection between the normal vector of the plane and the Poincaré sphere and whose initial point is at the origin of the Stokes space.

Note that the normal vector is determined so as to pass through the origin of the Stokes space. Further, there may be two normal vectors that pass through a specific point on a certain plane. Therefore, it is assumed that a rule for selecting the normal vector to be used to compute the SOP point from these two normal vectors has already been determined in advance.

Note that a plane in a Stokes space can be expressed as follows.

$$\begin{matrix}[ Equation 2 ] & \\ A * {s}_{1} + B * {s}_{2} + C * {s}_{3} + D = 0 & ( 2 )\end{matrix}$$

A, B, C, and D are real numbers.

Therefore, for example, the computing unit 2020 computes a plane fitting to the corresponding point group by computing A, B, C, and D that satisfy Equation (2) by using the corresponding point group. For example, the computing unit 2020 substitutes each of the corresponding points included in the corresponding point group into Equation (2) and performs singular value decomposition (SVD). In this way, since A, B, C, and D in Equation (2) are computed, a plane fitting to the corresponding point group is computed.

Note that in the case where quadrature amplitude modulation (QAM) is used, the corresponding point group is located inside a lens-shaped area that is obtained by combining an area defined by the following Equation (3) and an area defined by the following Equation (4).

$$\begin{matrix}[ Equation 3 ] & \\ S = \frac{1}{2} ( \begin{matrix}1 + {r}^{2} \\ 1 - {r}^{2} \\ 2 r cos φ \\ 2 r sin φ\end{matrix} ) & ( 3 )\end{matrix}$$

$$\begin{matrix}[ Equation 4 ] & \\ S = \frac{1}{2} ( \begin{matrix}{r}^{2} + 1 \\ {r}^{2} - 1 \\ 2 r cos φ \\ - 2 r sin φ\end{matrix} ) & ( 4 )\end{matrix}$$

In Equation (4), q and r represent the phase angle of the optical signal and the normalized amplitude thereof, respectively. Further, φ and r satisfy conditions 0<=φ<2π and 0<=r<=1, respectively.

A method for deriving Equation (3) is disclosed in NPL 2. In the derivation of Equation (3), a point having the maximum amplitude is selected for the H-polarization state. Further, all the points in the unit circle on the imaginary plane are taken into consideration for the V-polarization state. These facts are expressed by the following Jones vector.

$$\begin{matrix}[ Equation 5 ] & \\ J = \frac{1}{\sqrt{2}} ( \begin{matrix}1 \\ {re}^{j φ}\end{matrix} ) & ( 5 )\end{matrix}$$

Equation (3) is obtained by transforming the Jones vector expressed by Equation (5) into a Stokes vector.

Meanwhile, in the derivation of Equation (4), a point having the maximum amplitude is selected for the V-polarization state, and an arbitrary point(s) in the unit circle on the imaginary plane is taken into consideration for the H-polarization state. These facts are expressed by the following Jones vector.

$$\begin{matrix}[ Equation 6 ] & \\ J = \frac{1}{\sqrt{2}} ( \begin{matrix}{re}^{j φ} \\ 1\end{matrix} ) & ( 6 )\end{matrix}$$

Equation (4) is obtained by transforming the Jones vector expressed by Equation (6) into a Stokes vector.

Based on Equations (3) and (4), the aforementioned lens-shaped area is an area that is point-symmetrical with respect to the origin. Therefore, a plane that fits to the corresponding point group distributed inside this lens-shaped area passes through the origin. Therefore, it can be presumed that D is equal to zero (D=0) in Equation (2).

Therefore, the computing unit 2020 may compute a plane that fits to the corresponding point group by computing A, B, and C that satisfy the following equation by using the corresponding point group.

$$\begin{matrix}[ Equation 7 ] & \\ A * {s}_{1} + B * {s}_{2} + C * {s}_{3} = 0 & ( 7 )\end{matrix}$$

A, B, and C are real numbers.

Note that similarly to the case where Equation (2) is used, when Equation (7) is used, a plane that fits to the corresponding point group can also be computed by a method such as singular value decomposition.

The method for computing one SOP vector based on a plurality of corresponding points is not limited to the above-described method using a plane that fits to a plurality of corresponding points. For example, the computing unit 2020 may compute one corresponding point based on a plurality of corresponding points by using a method disclosed in NPL 1, and compute an SOP vector whose ending point is the computed corresponding point.

There are various methods by which the computing unit 2020 acquires sample data. For example, the receiving apparatus 200 is configured to generate sample data for each frame of an optical reception signal 20 and transmit the generated sample data to the SOP monitoring apparatus 2000. In this case, the computing unit 2020 receives sample data transmitted from the receiving apparatus 200, and thereby acquires the sample data. Alternatively, for example, the receiving apparatus 200 is configured to store sample data generated for each frame of an optical reception signal 20 into a storage unit accessible from the SOP monitoring apparatus 2000. In this case, the computing unit 2020 acquires sample data from this storage unit.

Note that in the case where the computing unit 2020 acquires sample data only for the representative frame, the receiving apparatus 200 may be configured to generate sample data only for the representative frame.

### <Calculation of SOP Change Vector: S104>

The computing unit 2020 computes an SOP change vector for each of a plurality of pairs of SOP vectors (S104). A pair of the SOP vectors includes, for example, SOP vectors adjacent to each other in time-series data of the SOP vectors (i.e., a plurality of SOP vectors arranged in a chronological order). For example, a set of pairs of the SOP vectors {(v[1], v[2]), (v[2], v[3]), . . . , (v[m−1], v[m])} is obtained from the time-series data of the SOP vectors (v[1], v[2], v[3], . . . , v[m]).

The SOP monitoring apparatus 2000 computes an SOP change vector for each pair included in this set. Specifically, the SOP monitoring apparatus 2000 computes an SOP change vector u[1] for a pair of SOP vectors (v[1], v[2]), an SOP change vector u[2] for a pair of SOP vectors (v[2], v[3]), . . . , and an SOP change vector u[m−1] for a pair of SOP vectors (v[m−1], v[m]). In this way, time-series data (u[1], u[2], . . . , u[m−1]) of SOP change vectors is obtained for set of pairs of SOP vectors {(v[1], v[2]), (v[2], v[3]), . . . , (v[m−1], v[m])}. Note that an i-th SOP change vector u[i] represents a difference between SOP vectors v[i] and v[i+1].

The pair of SOP vectors used for computing an SOP change vector is not limited to pairs of SOP vectors adjacent to each other in a chronological order. For example, the SOP monitoring apparatus 2000 may compute an SOP change vector u[i] by using SOP vectors v[k] and v[i+k] which are apart from each other by k (k is an integer of 2 or greater) as a pair of SOP vectors. Alternatively, for example, the computing unit 2020 may generate a pair of SOP vectors by randomly combining SOP vectors. In this case, the computing unit 2020 repeats a process in which it “extracts two arbitrary SOP vectors from the set of SOP vectors and computes an SOP change vector for a pair of these two SOP vectors” until the set of SOP vectors becomes empty.

### <Determination of Characteristic of Change in State of Polarization: S106>

The determining unit 2040 determines the characteristic of changes in the state of polarization of the optical reception signal 20 in the target monitoring period based on the directions of plurality of SOP change vectors, the lengths of the plurality of SOP change vectors, or both of them (S106). The characteristic of changes in the state of polarization can be classified, for example, as follows according to the characteristic of the movement of the end point of the SOP vector.

(Case 1) The end point of the SOP vector is rotating large and fast.
(Case 2) The end point of the SOP vector is rotating large and slowly.
(Case 3) The end point of the SOP vector is rotating small.
(Case 4) The end point of the SOP vector is not rotating.

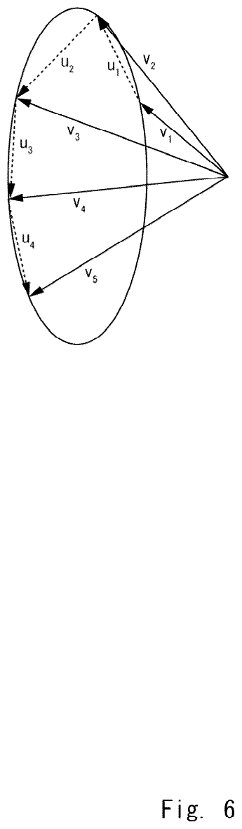

FIGS. 6 to 9 show examples of four cases each showing a characteristic of changes in the state of polarization. In each of FIGS. 6 to 9, five SOP vectors represented by v1, v2, v3, v4 and v5 are shown. Further, four SOP change vectors, i.e., a vector u1 representing a difference between v1 and v2, a vector u2 representing a difference between v2 and v3, a vector u3 representing a difference between v3 and v4, and a vector u4 representing a difference between v4 and v5, are shown.

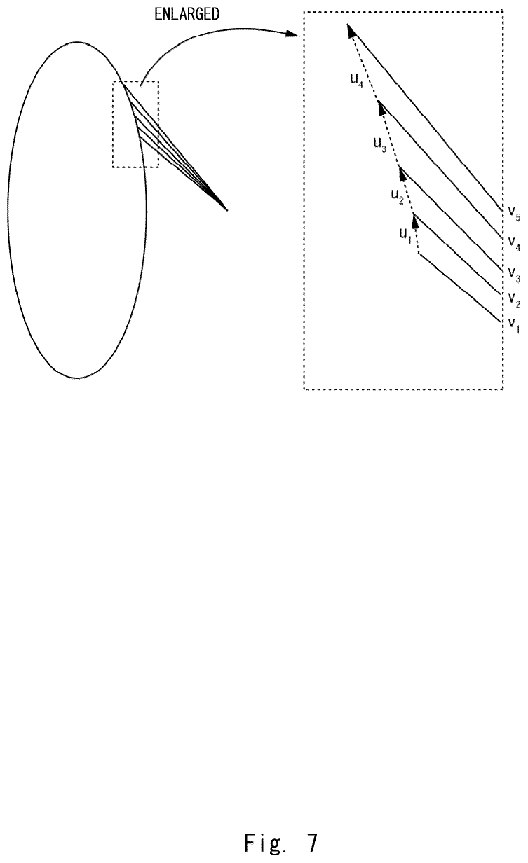

FIG. 6 shows an example case (Case 1) in which the end point of an SOP vector rotates large and fast. FIG. 7 shows an example case (Case 2) in which the end point of an SOP vector rotates large and slowly. In both cases shown in FIGS. 6 and 7, the end point of the SOP vector is rotating so as to draw a large circle. However, the end point of the SOP vector rotates more slowly in the case shown in FIG. 7 than in the case shown in FIG. 6.

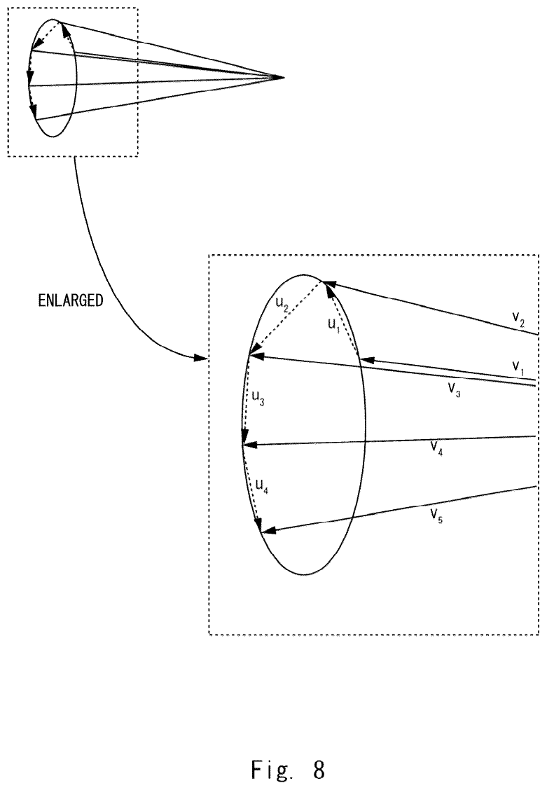

FIG. 8 shows an example case (Case 3) in which the end point of an SOP vector rotates small. The circle drawn by the end point of the SOP vector in the case shown in FIG. 8 is smaller than those drawn by the end points of the SOP vectors in the cases shown in FIGS. 6 and 7.

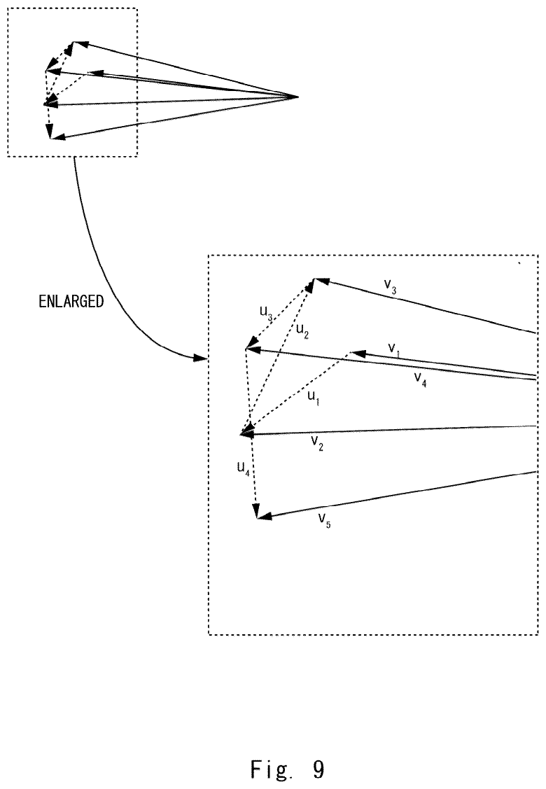

FIG. 9 shows an example case (Case 4) in which the end point of an SOP vector does not rotate. In the case shown in FIG. 9, unlike the cases shown in FIGS. 6 to 8, the end point of the SOP vector is not rotating.

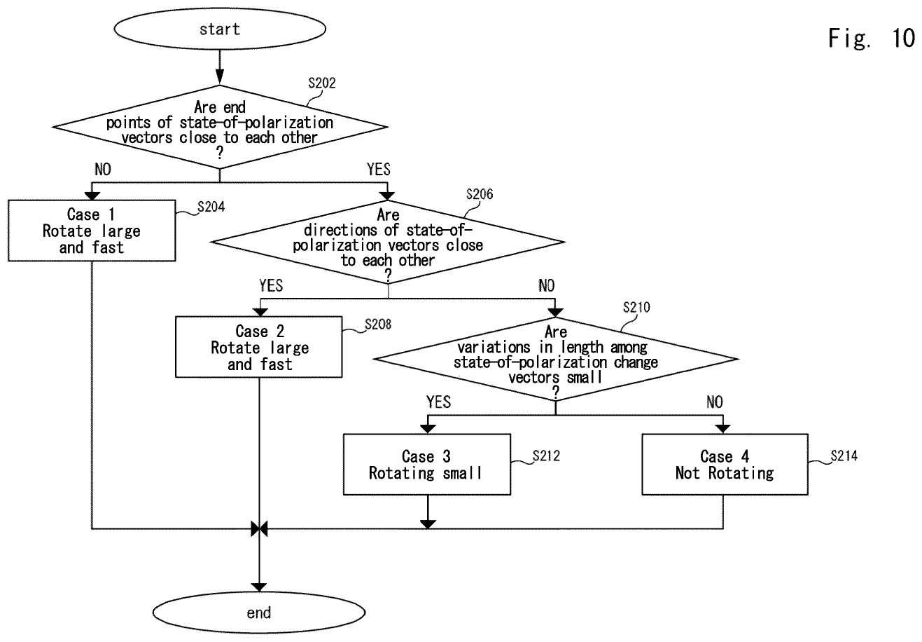

For example, the determining unit 2040 determine which of Cases 1 to 4 the characteristic of changes in the state of polarization of the optical reception signal 20 in the target monitoring period falls in by using a plurality of SOP change vectors. FIG. 10 is a flowchart showing an example of a flow of processes for determining a characteristic of changes in the state of polarization from among the four cases.

The determining unit 2040 determines whether or not the end points of a plurality of SOP vectors are located close to each other (S202). Note that when the SOP vector is rotating large and fast (i.e., in the case of Case 1), the end points of the plurality of SOP vectors are located distant from each other (see FIG. 6). In contrast, in the cases other than Case 1, the end points of the plurality of SOP vectors are located close to each other (see FIGS. 7, 8 and 9).

Therefore, when the end points of the plurality of SOP vectors are not located close to each other (S202: No), the determining unit 2040 determines that the characteristic of changes in the state of polarization of the optical reception signal 20 in the target monitoring period falls in Case 1 (S204).

When the end points of the plurality of SOP vectors are located close to each other (S202: Yes), the determining unit 2040 determines whether or not the plurality of SOP change vectors point in directions close to each other (S206). Note that as shown in FIG. 7, when the end point of the SOP vector is rotating large and slowly, the plurality of SOP change vectors point in directions close to each other. In contrast, when the end point of the SOP vector is rotating small or when the end point of the SOP vector is not rotating, the plurality of SOP change vectors do not point in directions close to each other (see FIGS. 8 and 9).

Therefore, when the plurality of SOP change vectors point in directions close to each other (S206: Yes), the determining unit 2040 determines that the characteristic of changes in the state of polarization of the optical reception signal 20 in the target monitoring period falls in Case 2 (S208).

When the plurality of SOP change vectors do not point in directions close to each other (S206: No), the determining unit 2040 determines whether or not variations in the length among the plurality of SOP change vectors are small (S210). Note that when the end point of the SOP vector is rotating small as shown in FIG. 8, variations in the length among the plurality of SOP change vectors are small. In contrast, when the end point of the SOP vector is not rotating as shown in FIG. 9, variations in the length among the plurality of SOP change vectors are large.

When variations in the length among the plurality of SOP change vectors are small (S210: Yes), the determining unit 2040 determines that the characteristic of changes in the state of polarization of the optical reception signal 20 in the target monitoring period falls in Case 3 (S212). In contrast, when variations in the length among the plurality of SOP change vectors are not small (S210: No), the determining unit 2040 determines that the characteristic of changes in the state of polarization of the optical reception signal 20 in the target monitoring period falls in Case 4 (S214).

Note that it is possible to determine whether or not variations in the length among the plurality of SOP change vectors are small, for example, by determining whether or not the variations in the length among the plurality of SOP change vectors are equal to or smaller than a predetermined threshold.

### <<Regarding S202>>

In the step S202, the determining unit 2040 determines whether or not the end points of the plurality of SOP vectors are located close to each other. There are various methods for this determination. For example, the determining unit 2040 determines whether or not the end points of the plurality of SOP vectors are located close to each other based on a statistical value (a mean value, a maximum value, a minimum value, or the like) of the lengths of SOP change vectors.

It is considered that when the end points of the plurality of SOP vectors are located close to each other, the lengths of all of the plurality of SOP change vectors are short. Therefore, when the statistical value of the lengths of the SOP change vectors is equal to or smaller than the predetermined threshold, it can be found that the end points of the plurality of SOP vectors are located close to each other. On the other hand, when the statistical value of the lengths of the SOP change vectors is larger than the predetermined threshold, it can be found that the end points of the plurality of SOP vectors are not located close to each other.

Therefore, the determining unit 2040 determines whether or not the statistical value of the lengths of the SOP change vectors is equal to or smaller than the predetermined threshold. This threshold is determined in advance in order to determine whether the statistical value of the lengths of the SOP change vectors is small enough to indicate that the end points of the plurality of SOP vectors are located close to each other.

When the statistical value of the lengths of the SOP change vectors is not equal to nor smaller than the predetermined threshold, the determining unit 2040 determines that the characteristic of changes in the state of polarization of the optical reception signal 20 in the target monitoring period falls in Case 1 (S204). When the statistical value of the lengths of SOP change vectors is not equal to nor smaller than the predetermined threshold, the determining unit 2040 performs the step S206.

Whether or not the end points of the plurality of SOP vectors are located close to each other may be determined based on the magnitudes of the rotation angles of the SOP vectors. In this case, the determining unit 2040 computes, for each of the pairs of SOP vectors described above, the rotation angle of the SOP vector. Then, the determining unit 2040 computes a statistical value (a mean value, a maximum value, a minimum value, or the like) of the computed plurality of rotation angles.

It is considered that when the end points of the plurality of SOP vectors are located close to each other, the rotation angles of all the SOP vectors are small. Therefore, when the statistical value of the rotation angles of SOP vectors is equal to or smaller than the predetermined threshold, it can be found that the end points of the plurality of SOP vectors are located close to each other. On the other hand, when the statistical value of the rotation angles of SOP vectors is larger than the predetermined threshold, it can be found that the end points of the plurality of SOP vectors are not located close to each other.

Therefore, the determining unit 2040 determines whether or not the statistical value of the rotation angles of SOP vectors is equal to or smaller than the predetermined threshold. This threshold is determined in advance in order to determine whether or not the statistical value of the rotation angles of SOP vectors is small enough to indicate that the end points of the plurality of SOP vectors are located close to each other.

When the statistical value of the rotation angles of SOP vectors is not equal or smaller than the predetermined threshold, the determining unit 2040 determines that the characteristic of changes in the state of polarization of the optical reception signal 20 in the target monitoring period falls in Case 1 (S204). When the statistical value of the rotation angles of SOP vectors is equal to or smaller than the predetermined threshold, the determining unit 2040 performs the step S206.

### <<Regarding S206>>

In the step S206, the determining unit 2040 determines whether or not the plurality of SOP change vectors point in directions close to each other. It is possible to determine whether or not the plurality of SOP change vectors point in directions close to each other, for example, based on variations in the direction among the plurality of SOP change vectors.

It is considered that when the plurality of SOP change vectors point in directions close to each other, variations in the direction among the plurality of SOP change vectors are small. Therefore, when the variations in the direction among the SOP change vectors are equal to or smaller than the predetermined threshold, it can be found that the plurality of SOP change vectors point in directions close to each other. In contrast, when the variations in the direction among the SOP change vectors are larger than the predetermined threshold, it can be found that the plurality of SOP change vectors do not point in directions close to each other.

Therefore, the determining unit 2040 computes variations in the direction among the SOP change vectors and determines whether or not the computed variations are equal to or smaller than the predetermined threshold. This threshold is determined in advance in order to determine whether or not variations in the direction among the SOP change vectors are small enough to indicate that the plurality of SOP change vectors point in directions close to each other.

When the variations in the direction among the SOP change vectors are equal to or smaller than the predetermined threshold, the determining unit 2040 determines that the characteristic of changes in the state of polarization of the optical reception signal 20 in the target monitoring period falls in Case 2 (S208). In contrast, when the variations in the direction among the SOP change vectors are larger than the predetermined threshold, the determining unit 2040 performs the step S210.

### <Output of Processing Result>

The SOP monitoring apparatus 2000 may be configured to output information indicating the results of processing (hereinafter also referred to as result information). The result information indicates, for example, information indicating the target monitoring period and information indicating the characteristic of changes in the state of polarization of the optical reception signal 20 in the target monitoring period. The information indicating the target monitoring period indicates, for example, the start point and the end point of the target monitoring period. The information indicating the characteristic of changes in the state of polarization of the optical reception signal 20 indicates, for example, label representing one of the above-described Cases 1 to 4.

There are various output modes for the result information. For example, the SOP monitoring apparatus 2000 stores the result information in an arbitrary storage unit. Alternatively, for example, the SOP monitoring apparatus 2000 outputs the result information to a display device and thereby makes the display device display contents of the result information. Further, for example, the SOP monitoring apparatus 2000 transmits the result information to another apparatus (e.g., a terminal that the user of the SOP monitoring apparatus 2000 operates).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the example embodiments disclosed above can be described as, but not limited to, the following supplementary notes.

### (Supplementary Note 1)

A state-of-polarization monitoring apparatus comprising:
computing means for computing a state-of-polarization change vector representing a change in the state of polarization of an optical reception signal for each of different periods; and
determining means for determining a characteristic of the change in the state of polarization of the optical reception signal based on a direction of each of the state-of-polarization change vectors, a length of each of the state-of-polarization change vectors, or both of them.

### (Supplementary Note 2)

The state-of-polarization monitoring apparatus described in Supplementary note 1, wherein the determining means determines whether or not the characteristic of the change in the state of polarization of the optical reception signal has a characteristic that a state-of-polarization vector representing the state of polarization of the optical reception signal rotates large and slowly based on closeness of directions of a plurality of state-of-polarization change vectors.

### (Supplementary Note 3)

The state-of-polarization monitoring apparatus described in Supplementary note 2, wherein the determining means determines that the characteristic of the change in the state of polarization of the optical reception signal has the characteristic that the state-of-polarization vector rotates large and slowly when variations in direction among the plurality of state-of-polarization change vectors is equal to smaller than a threshold.

### (Supplementary Note 4)

The state-of-polarization monitoring apparatus described in Supplementary note 1, wherein the determining means determines whether or not the characteristic of the change in the state of polarization of the optical reception signal has a characteristic that a state-of-polarization vector representing the state of polarization of the optical reception signal rotates small based on variations in length among a plurality of state-of-polarization change vectors.

### (Supplementary Note 5)

The state-of-polarization monitoring apparatus described in Supplementary note 4, wherein the determining means determines that the characteristic of the change in the state of polarization of the optical reception signal has the characteristic that the state-of-polarization vector rotates small when the variations in length among the plurality of state-of-polarization change vectors is equal to smaller than a threshold.

### (Supplementary Note 6)

The state-of-polarization monitoring apparatus described in Supplementary note 1, wherein the determining means determines whether or not the characteristic of the change in the state of polarization of the optical reception signal has a characteristic that a state-of-polarization vector representing the state of polarization of the optical reception signal rotates large and fast based on closeness of end points of a plurality of state-of-polarization vectors representing the state of polarization of the optical reception signal.

### (Supplementary Note 7)

The state-of-polarization monitoring apparatus described in Supplementary note 6, wherein the determining means
determines that the characteristic of the change in the state of polarization of the optical reception signal has a characteristic that the state-of-polarization vector is rotating large and fast when a statistical value of magnitudes of rotation angles of the plurality of state-of-polarization vectors is equal to or larger than a threshold, or
determines that the characteristic of the change in the state of polarization of the optical reception signal has a characteristic that the state-of-polarization vector is rotating large and fast when a statistical value of lengths of the plurality of state-of-polarization change vectors is equal to or larger than a threshold.

### (Supplementary Note 8)

A state-of-polarization monitoring method performed by a computer, comprising:
a computing step of computing a state-of-polarization change vector representing a change in the state of polarization of an optical reception signal for each of different periods; and
a determining step of determining a characteristic of the change in the state of polarization of the optical reception signal based on a direction of each of the state-of-polarization change vectors, a length of each of the state-of-polarization change vectors, or both of them.

### (Supplementary Note 9)

The state-of-polarization monitoring method described in Supplementary note 8, wherein in the determining step, it is determined whether or not the characteristic of the change in the state of polarization of the optical reception signal has a characteristic that a state-of-polarization vector representing the state of polarization of the optical reception signal rotates large and slowly based on closeness of directions of a plurality of state-of-polarization change vectors.

### (Supplementary Note 10)

A program for causing a computer to perform:
a computing step of computing a state-of-polarization change vector representing a change in the state of polarization of an optical reception signal for each of different periods; and
a determining step of determining a characteristic of the change in the state of polarization of the optical reception signal based on a direction of each of the state-of-polarization change vectors, a length of each of the state-of-polarization change vectors, or both of them.

Some or all of the elements (e.g., structures and functions) described in Supplementary notes 2 to 6 that are dependent on Supplementary note 1 (apparatus) can be dependent on Supplementary note 8 (method) by the same dependency relationships as those in Supplementary notes 2 to 6. Some or all of the elements (e.g., structures and functions) described in Supplementary notes 2 to 7 that are dependent on Supplementary note 1 (apparatus) can be dependent on Supplementary note 10 (program) by the same dependency relationships as those in Supplementary notes 2 to 7. Some or all of the elements described in any of the supplementary notes can be applied to various types of hardware, software, recording means for recording software, systems, and methods.

What is claimed is:

1. A state-of-polarization monitoring apparatus comprising:
at least one memory that is configured to store instructions; and
at least one processor that is configured to execute the instructions to:
computing a state-of-polarization change vector representing a change in the state of polarization of an optical reception signal for each of different periods; and
determining a characteristic of the change in the state of polarization of the optical reception signal based on a direction of each of the state-of-polarization change vectors, a length of each of the state-of-polarization change vectors, or both of them.

2. The state-of-polarization monitoring apparatus according to claim 1, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates large and slowly based on closeness of directions of the plurality of state-of-polarization change vectors.

3. The state-of-polarization monitoring apparatus according to claim 2, wherein the change in the state of polarization of the optical reception signal is determined to have the characteristic that the state-of-polarization vector rotates large and slowly when variations in direction among the plurality of state-of-polarization change vectors is equal to smaller than a threshold.

4. The state-of-polarization monitoring apparatus according to claim 1, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates small based on variations in length among the plurality of state-of-polarization change vectors.

5. The state-of-polarization monitoring apparatus according to claim 4, wherein the change in the state of polarization of the optical reception signal is determined to have the characteristic that the state-of-polarization vector rotates small when the variations in length among the plurality of state-of-polarization change vectors is equal to smaller than a threshold.

6. The state-of-polarization monitoring apparatus according to claim 1, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates large and fast based on closeness of end points of the plurality of state-of-polarization vectors representing the state of polarization of the optical reception signal.

7. The state-of-polarization monitoring apparatus according to claim 6,
wherein the determination of the characteristic of the change in the state of polarization of the optical reception signal includes:
determining that the change in the state of polarization of the optical reception signal has the characteristic that the state-of-polarization vector is rotating large and fast when a statistical value of magnitudes of rotation angles of the plurality of state-of-polarization vectors is equal to or larger than a threshold; or
determining that the change in the state of polarization of the optical reception signal has the characteristic that the state-of-polarization vector is rotating large and fast when a statistical value of lengths of the plurality of state-of-polarization change vectors is equal to or larger than a threshold.

8. A state-of-polarization monitoring method performed by a computer, comprising:
computing a state-of-polarization change vector representing a change in the state of polarization of an optical reception signal for each of different periods; and
determining a characteristic of the change in the state of polarization of the optical reception signal based on a direction of each of the state-of-polarization change vectors, a length of each of the state-of-polarization change vectors, or both of them.

9. The state-of-polarization monitoring method according to claim 8, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates large and slowly based on closeness of directions of the plurality of state-of-polarization change vectors.

10. The state-of-polarization monitoring method according to claim 9, wherein the change in the state of polarization of the optical reception signal is determined to have the characteristic that the state-of-polarization vector rotates large and slowly when variations in direction among the plurality of state-of-polarization change vectors is equal to smaller than a threshold.

11. The state-of-polarization monitoring method according to claim 8, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates small based on variations in length among the plurality of state-of-polarization change vectors.

12. The state-of-polarization monitoring method according to claim 11, wherein the change in the state of polarization of the optical reception signal is determined to have the characteristic that the state-of-polarization vector rotates small when the variations in length among the plurality of state-of-polarization change vectors is equal to smaller than a threshold.

13. The state-of-polarization monitoring method according to claim 8, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates large and fast based on closeness of end points of the plurality of state-of-polarization vectors representing the state of polarization of the optical reception signal.

14. The state-of-polarization monitoring method according to claim 13,
wherein the determination of the characteristic of the change in the state of polarization of the optical reception signal includes:
determining that the change in the state of polarization of the optical reception signal has the characteristic that the state-of-polarization vector is rotating large and fast when a statistical value of magnitudes of rotation angles of the plurality of state-of-polarization vectors is equal to or larger than a threshold; or
determining that the change in the state of polarization of the optical reception signal has the characteristic that the state-of-polarization vector is rotating large and fast when a statistical value of lengths of the plurality of state-of-polarization change vectors is equal to or larger than a threshold.

15. A non-transitory computer readable medium storing a program for causing a computer to perform:
computing a state-of-polarization change vector representing a change in the state of polarization of an optical reception signal for each of different periods; and
determining a characteristic of the change in the state of polarization of the optical reception signal based on a direction of each of the state-of-polarization change vectors, a length of each of the state-of-polarization change vectors, or both of them.

16. The medium according to claim 15, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates large and slowly based on closeness of directions of the plurality of state-of-polarization change vectors.

17. The medium according to claim 16, wherein the change in the state of polarization of the optical reception signal is determined to have the characteristic that the state-of-polarization vector rotates large and slowly when variations in direction among the plurality of state-of-polarization change vectors is equal to smaller than a threshold.

18. The medium according to claim 15, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates small based on variations in length among the plurality of state-of-polarization change vectors.

19. The medium according to claim 18, wherein the change in the state of polarization of the optical reception signal is determined to have the characteristic that the state-of-polarization vector rotates small when the variations in length among the plurality of state-of-polarization change vectors is equal to smaller than a threshold.

20. The medium according to claim 15, wherein the determination of the characteristic of the change in the state of polarization of the optical reception signal includes determining whether or not the change in the state of polarization of the optical reception signal has a characteristic that a state-of-polarization vector representing the state of polarization of the optical reception signal rotates large and fast based on closeness of end points of the plurality of state-of-polarization vectors representing the state of polarization of the optical reception signal.
